(19) United States
(12) Patent Application Publication
(10) Pub. No.: US 2011/0159347 A1
(43) Pub. Date: Jun. 30, 2011

(54) SEPARATOR FOR LITHIUM SECONDARY BATTERY AND LITHIUM SECONDARY BATTERY USING THE SAME

(76) Inventors: Yasuyuki Shibano, Nara (JP); Norihiro Yamamoto, Osaka (JP); Yasuo Shinohara, Ibaraki (JP); Koichiro Watanabe, Ehime (JP)

(21) Appl. No.: 13/062,151

(22) PCT Filed: Apr. 6, 2010
(86) PCT No.: PCT/JP2010/002519

§ 371 Date: Mar. 3, 2011

(30) Foreign Application Priority Data
Apr. 7, 2009 (JP) 2009-093037

(51) Int. Cl. H01M 2/16

(52) U.S. Cl. 429/144

(57) ABSTRACT

A separator 4 for a lithium secondary battery includes a porous film 12 including a polyolefin layer 16 and a lubricant layer 14 disposed on a surface of the porous film 12. The lubricant layer 14 includes a particulate substance 22 and has a three-dimensional surface roughness of 0.15 to 1.45 μm. The particulate substance 22 can adhere to the surface of the porous film 12 by electrostatic attraction. The porous film 12 can further include a heat-resistant porous layer 18 between the polyolefin layer 16 and the lubricant layer 14. The separator 4 allows a winding core for the lithium secondary battery to be pulled out smoothly.

### TECHNICAL FIELD

This invention relates to a separator for a lithium secondary battery and a lithium secondary battery using the same. More particularly, it relates to an improvement for facilitating the fabrication of an electrode assembly of a lithium secondary battery.

### BACKGROUND ART

Recently, lithium secondary batteries, which can be repeatedly charged and discharged and have high energy density, are used as the power source for mobile devices such as notebook personal computers and cellular phones. However, due to high energy density, when lithium secondary batteries are misused, for example, externally short-circuited, the battery reactions can become violent, causing the battery temperature to increase. Therefore, lithium secondary batteries are equipped with a safety mechanism such as a PTC (Positive Temperature Coefficient) device or an SU circuit (protective circuit). Further, the separator interposed between the power-storing positive and negative electrodes is also equipped with a safety mechanism to prevent the battery temperature from increasing. The separator comprises a porous film containing a polyolefin.

In lithium secondary batteries, lithium ions move between the positive electrode and the negative electrode through the non-aqueous electrolyte retained in the pores of the separator. However, when the battery temperature increases due to an external short circuit or the like, the heat produced thereby melts the polyolefin, thereby closing the pores of the separator and making the lithium ions unable to move. As a result, an increase in battery temperature can be suppressed. Such safety function of the separator is called shutdown function. It is widely known that when polyethylene (PE) or polypropylene (PP) is used as the material of the separator, the shutdown function is effectively exhibited.

In the production of a lithium secondary battery, first, a positive electrode, a negative electrode, and a separator, which are in sheet form, are spirally wound to form an electrode assembly in which the positive electrode and the negative electrode are alternately layered with the separator interposed therebetween. Next, the electrode assembly is inserted into a battery case with a bottom, and a non-aqueous electrolyte is injected therein. The opening of the battery case is sealed to produce a lithium secondary battery.

In forming the electrode assembly, the end of the separator is clamped between two metal winding cores, and the two winding cores are rotated to wind the positive electrode and the negative electrode together with the separator. They are wound in such a manner that the separator is interposed between the positive electrode and the negative electrode and positioned as the innermost layer. After the completion of the winding, the clamping two winding cores are released, and the winding cores are pulled out of the electrode assembly.

At this time, if the separator has poor slidability with respect to the winding cores, the winding cores may not be smoothly pulled out of the electrode assembly, or the separator may stick to the burrs of the electrodes, thereby becoming damaged. Thus, the process of pulling out the winding cores needs to be constantly monitored, thereby resulting in increased production costs. If there is a problem with the process of pulling out the winding cores, the production line needs to be stopped to make a readjustment, thereby resulting in decreased productivity.

Therefore, improving the slidability of the separator with respect to the winding cores is important in reducing the production cost, increasing the productivity, and producing a high reliable electrode assembly and hence a highly reliable lithium secondary battery.

PTL 1 proposes embedding particles in the surface of a separator in such a manner that the particles partially protrude therefrom, in order to improve the slidability of the separator.

PTL 2 proposes using a porous film having an exterior surface portion of polypropylene which contains at least 50 ppm of calcium stearate as a separator.

### CITATION LIST

### Patent Literature

[PTL 1] Japanese Laid-Open Patent Publication No. Hei 10-110052
[PTL 2] Japanese Laid-Open Patent Publication No. 2003-157824

### SUMMARY OF INVENTION

### Technical Problem

In PTL 1, the portions of the porous film where the spherical particles do not protrude may come into contact with the winding core. If the surface of the porous film comes into direct contact with the winding core, it is difficult to pull out the winding core smoothly. Also, since the spherical particles are embedded in the porous film, the slidability is insufficient.

Further, the above-mentioned conventional techniques are mainly intended to improve cylindrical batteries, and cannot provide a sufficient improvement in prismatic batteries. More specifically, winding cores for the electrode assemblies of cylindrical batteries are cylindrical (in the shape of a pole), so the separator is uniformly pressed against the winding core. In contrast, winding cores for the electrode assemblies of prismatic batteries are flat (in the shape of a plate), so the separator is intensively pressed against the edges of the winding core. As such, in the case of prismatic batteries, it is more difficult to pull out the winding core from the electrode assembly than in the case of cylindrical batteries.

Usually, porous films are formed by extrusion. In order to provide an extruded film with good core removal properties by causing spherical particles to partially protrude from the surface of the extruded film, it is necessary to add a large amount of particles. However, if a large amount of such particles are added to a resin which is a material of the porous film, the film formability decreases.

As in PTL 2, with only the addition of calcium stearate, it is difficult to sufficiently improve the core removal properties in the battery. Further, if the content of calcium stearate is increased, the film formability decreases in the same manner as described above.

In view of the above-noted problems, the invention provides a separator for a lithium secondary battery which allows a winding core to be smoothly pulled out of the wound electrode assembly.

### Solution to Problem

One aspect of the invention relates to a separator for a lithium secondary battery, including: a porous film including a polyolefin layer; and a lubricant layer disposed on a surface of the porous film, the lubricant layer including a particulate substance and having a three-dimensional surface roughness of 0.15 to 1.45 μm.

Another aspect of the invention relates to a lithium secondary battery including: an electrode assembly comprising a positive electrode, a negative electrode, and the above-mentioned separator interposed between the positive electrode and the negative electrode; a non-aqueous electrolyte; and a battery case for housing the electrode assembly and the non-aqueous electrolyte.

While the novel features of the invention are set forth particularly in the appended claims, the invention, both as to organization and content, will be better understood and appreciated, along with other objects and features thereof, from the following detailed description taken in conjunction with the drawings.

### ADVANTAGEOUS EFFECTS OF INVENTION

According to the invention, when a positive electrode, a negative electrode, and a separator are spirally wound to form an electrode assembly by using a winding core, the slidability of the separator with respect to the winding core can be significantly improved. As a result, the removal of the winding core from the electrode assembly is improved, and the operation of pulling out the winding core can be smoothly performed.

### BRIEF DESCRIPTION OF DRAWINGS

FIG. 1 is a schematic cross-sectional view of a lithium secondary battery according to one embodiment of the invention;

FIG. 2 is a plan view schematically showing the layout of winding cores and an electrode assembly for forming an electrode assembly; and

FIG. 3 is a schematic sectional view of a separator for a lithium secondary battery according to one embodiment of the invention.

### DESCRIPTION OF EMBODIMENTS

Embodiments of the invention are hereinafter described with reference to drawings.

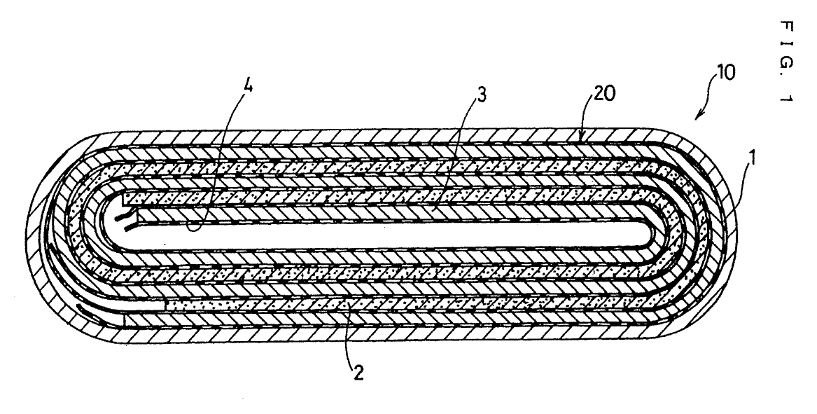

FIG. 1 is a schematic cross-sectional view of a prismatic lithium secondary battery as an embodiment of the invention.

A battery 10 comprises a thin battery case 1 shaped like a box, an electrode assembly 20 contained in the case 1, and a non-aqueous electrolyte (not shown). The electrode assembly 20 has a rectangular flat face and curved side faces on both sides of the flat face.

The electrode assembly 20 is produced by spirally winding a long-strip like positive electrode 2, a long-strip like negative electrode 3, and a long-strip like separator 4 interposed therebetween. At this time, another separator 4 is disposed at the innermost portion of the electrode assembly 20. In the example illustrated in FIG. 1, the positive electrode 2, the negative electrode 3, and the separators 4 are wound in such a manner that the innermost separator 4 contacts the negative electrode 3.

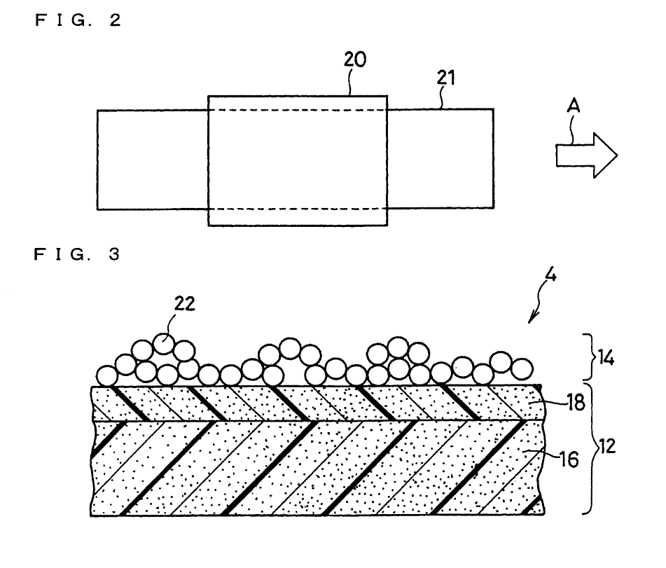

FIG. 2 is a top view schematically showing the structure of the electrode assembly 20 using winding cores. In the case of a prismatic battery, two rectangular, metal thin plates are used as winding cores 21, and the positive electrode 2 and the negative electrode 3 are wound with the separators 4 interposed between the winding cores 21. More specifically, one of the separators 4, one of the positive electrode 2 and the negative electrode 3, the other of the separators 4, and the other of the positive electrode 2 and the negative electrode 3 are stacked in this order, and the ends of the two separators 4 are clamped between the two winding cores 21. In this state, the winding cores 21 are rotated to form the wound electrode assembly 20 having a layered structure. After the formation, the two winding cores 21 are moved apart from each other to unclamp the ends of the separators 4, and the winding cores 21 are pulled out of the electrode assembly 20 in the direction of the arrow A.

FIG. 3 is a schematic sectional view of the separator 4. The separator 4 includes a porous film 12 and a lubricant layer 14 which is disposed on a surface of the porous film 12 and contains a particulate substance 22.

The porous film 12 illustrated therein has a porous polyolefin layer 16 composed mainly of, for example, polyethylene (PE) and a heat-resistant porous layer 18 interposed between the polyolefin layer 16 and the lubricant layer 14. The heat-resistant porous layer 18 contains, for example, a polyamide as the main component.

In the example illustrated in FIG. 3, the heat-resistant porous layer 18 is formed on only one face of the polyolefin layer 16, and the lubricant layer 14 is formed on a surface of the heat-resistant porous layer 18. The heat-resistant porous layer 18 may be formed on both faces of the polyolefin layer 16. The lubricant layer 14 is formed on at least one face of the porous film 12, and may be formed on both faces. It is also possible to form the heat-resistant porous layer 18 on both faces of the polyolefin layer 16 and form the lubricant layer 14 on a surface of one of the heat-resistant porous layers 18. It should be noted that FIG. 3 schematically shows an example of the layout of the heat-resistant porous layer 18 and the lubricant layer 14, and that the ratio of the thicknesses of the respective layers is not necessarily the same as the actual one.

The lubricant layer 14 is provided on a surface of the porous film 12 in order to allow the winding cores to be smoothly pulled out of the electrode assembly 20 after the electrode assembly 20 is formed. Therefore, the lubricant layer 14 does not always need to be formed on the whole separator 14, and may be formed on only the portion of the separator 14 to come into contact with the winding core when wound. It is also possible to form the lubricant layer on the portion of the separator 4 to come into contact with the winding core, for example, the portion of the separator 4 to be disposed at the innermost portion of the electrode assembly, while not forming the lubricant layer on the portion excluding the innermost portion (the portion interposed between the positive electrode and the negative electrode).

In the case of a prismatic battery, particularly large friction occurs between the innermost surface of the separator 4 and the side edge portions of the winding core 21 in contact with the innermost surface thereof. Thus, the lubricant layer 14 may be formed only on the portion of the separator 4 to come into contact with the side edge portions of the winding core.

In the example illustrated in FIG. 3, the lubricant layer 14 is formed, for example, by disposing the particulate substance 22 such as polytetrafluoroethylene particles on a surface of the heat-resistant porous layer 18. The lubricant layer 14 may also be formed by applying a dispersion containing the particulate substance 22 on a surface of the heat-resistant porous layer 18 and drying it to attach the particulate substance 22 to the surface of the heat-resistant porous layer 18. The dispersion can be an aqueous dispersion containing a surfactant.

The lubricant layer 14 is free from a binder such as a resin and comprises the particulate substance 22 adhering to a surface of the polyolefin layer 16 or the heat-resistant porous layer 18 by electrostatic attraction, the action of a surfactant, or the like. The respective particles of the particulate substance 22 agglomerate by electrostatic attraction, the action of a surfactant, or the like. Hence, when the lubricant layer 14 is subjected to such an external force as when rubbed by a finger, the particulate substance 22 moves. The lubricant layer thus has high slidability. That is, the particulate substance 22 is disposed in such a manner that it is capable of moving over the porous film 12.

The lubricant layer 14, which comprises the particulate substance 22 disposed on the surface of the porous film 12, has a specific surface roughness.

The surface roughness of the lubricant layer 14, for example, in the initial state immediately after the drying or before the formation of the electrode assembly, is set so that the surface roughness Sa (three-dimensional surface roughness) is 0.15 to 1.45 μm.

The surface roughness Sa as used herein can be determined by dividing the volume of the portion surrounded by the roughness curve of the surface of the lubricant layer (hereinafter referred to as surface roughness profile) and the mean plane of the roughness by the measured area. That is, when the mean plane is represented by the X-Y plane, the height direction is represented by the Z axis, and the measured area z of the surface roughness profile is represented by z=f(x, y), the surface roughness Sa is defined by the following formula (Math. 1).

$${S}_{a} = \frac{1}{{L}_{x} {L}_{y}} {\int }_{0}^{{L}_{x}} {\int }_{0}^{{L}_{y}} f ( x , y ) d x d y \qquad [ Math . 1 ]$$

In the formula (Math. 1), Lₓ represents the measured length in the X direction, and L_{y} represents the measured length in the Y direction. This measurement can be made by a non-contact surface measurement using a laser beam or an electron beam.

### [Separator]

### (Lubricant Layer)

The three-dimensional surface roughness Sa of the lubricant layer is preferably 0.18 to 1.42 μm, more preferably 0.19 to 1.41 μm, and particularly 0.2 to 1.4 μm. If the surface roughness Sa is less than 0.15 μm, the contact area of the winding core 21 and the lubricant layer 14 increases, thereby resulting in poor slidability.

On the other hand, if the surface roughness Sa exceeds 1.45 μm, the amount of the particulate substance 22 which falls off the lubricant layer 14 increases, or the distance between the positive electrode 2 and the negative electrode 3 which are disposed so as to sandwich the separator 4 becomes uneven. As a result, the battery characteristics may be impaired.

The three-dimensional surface roughness can be adjusted by suitably selecting the kind, shape, and size (particle size) of the particulate substance, the weight of the particulate substance contained in the lubricant layer, and the like. For example, the size of the particulate substance and/or the weight of the particulate substance in the lubricant layer are/is adjusted.

The particulate substance 22 is not limited to the above-mentioned polytetrafluoroethylene, and particulate substances such as organic polymer compounds and inorganic compounds can be used. It is preferable that the particulate substance 22 be electrochemically stable, since during the use of the secondary battery, the particulate substance 22 having fallen off may come into contact with the positive electrode 2 or the negative electrode 3. It is also preferable that the particulate substance 22 be stable with respect to the solvent (e.g., organic solvent) contained in the non-aqueous electrolyte, since it comes into contact with the non-aqueous electrolyte inside the battery case 1.

Examples of the organic polymer compound forming the particulate substance 22 are organic polymers including: halogen-atom containing polymers such as fluorine-containing polymers (e.g., homopolymers or copolymers including a halogen-atom containing olefin such as a vinyl halide as a constituent monomer); polyolefins (e.g., olefin homopolymers or olefin copolymers such as polyethylene, polypropylene, and an ethylene-propylene copolymer); and polyesters (e.g., polyalkylene terephthalates such as polyethylene terephthalate and polybutylene terephthalate). Among these organic polymer compounds, fluorine-containing polymers (e.g., fluorine-containing polymers with a low wear coefficient) and polyolefins are preferable. Preferable examples of fluorine-containing polymers include: fluoroolefin homopolymers and fluoroolefin copolymers such as polytetrafluoroethylene (PTFE) and a perfluoroethylene propylene copolymer (FEP); olefin-fluoroolefin copolymers such as ethylene-tetrafluoroethylene copolymer (ETFE); and fluoroolefin-fluoroalkyl vinyl ether copolymers such as a perfluoroalkoxyalkane polymer (PFA).

Examples of the inorganic compound include: oxides of at least one element selected from silicon, aluminum, titanium, magnesium, zirconium, calcium, and the like (e.g., silica, alumina, titania, magnesia, zirconia, and calcium oxide); nitrides or carbonates of such elements; and silicate minerals such as talc and mica. Among these inorganic compounds, the oxides or carbonates (e.g., chemical compositions represented by SiO₂, Al₂O₃, TiO₂, M_{g}O, ZrO₂, CaO, and CaCO₃), talc, mica, and the like are preferable.

Such particulate substances (organic polymer compounds and/or inorganic compounds) can be used singly or in combination.

While the particulate substance 22 may be in the shape of, for example, a short fiber or a needle, it is usually particles which are in the shape of, for example, a sphere, a spheroid, a plate, or a bar. In order to provide the lubricant layer 14 with high slidability with respect to the winding core, the particulate substance 22 is preferably spherical particles (e.g., spherical or substantially spherical particles with an average aspect ratio of approximately 1 to 2).

The mean particle size (median diameter in the volume basis particle size distribution) of the particulate substance 22 is, for example, 0.01 to 1 μm, preferably 0.02 to 0.9 μm, and more preferably 0.03 to 0.8 μm. If the mean particle size is too small, the surface of the lubricant layer 14 becomes flat, and it is difficult to adjust the surface roughness Sa. If the mean particle size of the particulate substance 22 is too large, the surface roughness Sa increases, but the exposed portions of the porous film 12 increase, which may result in poor slidability due to the lubricant layer 14.

The particulate substance 22 may comprise a mixture of two or more kinds of particles that are different in mean particle size and/or material.

The weight (dry weight) of the particulate substance 22 of the lubricant layer 14 per 1 m² of the surface of the porous film 12 can be selected from the range of, for example, 0.1 to 2 g, preferably 0.1 to 1.5 g, more preferably 0.2 to 1 g, and particularly 0.2 to 0.8 g, although it depends on the kind of the particulate substance.

If the weight of the particulate substance 22 per unit area of the lubricant layer 14 is too small, the area of the porous film 12 with poor slidability to come into direct contact with the winding core 21 increases, and the removal of the winding core 21 may become difficult.

The lubricant layer 14 can be formed by not only the above-mentioned application but also a method such as printing or spraying as long as the particulate substance 22 can be disposed on a surface of the porous film 12.

The particulate substance 22 can be usually disposed by applying a dispersion comprising the particulate substance dispersed in a dispersion medium onto a surface of the porous film 12 by such a method as application and drying the dispersion medium.

Examples of the dispersion medium include: water; alcohols (C₂₋₄ alkanols or C₂₋₄ alkane diols) such as methanol, ethanol, and ethylene glycol; ketones such as acetone; ethers such as diethyl ether; nitriles such as acetonitrile; and N-methyl-2-pyrrolidone (NMP). These dispersion media can be used singly or in combination.

The dispersion may contain a surfactant, if necessary. Examples of surfactants include: anion surfactants such as salts of alkyl sulfonates; nonionic surfactants such as polyoxyethylene alkyl ethers, polyoxyalkylene derivatives, and sorbitan fatty acid esters; cationic surfactants such as alkyl amine salts; and amphoteric surfactants such as alkyl betaines. These surfactants can be used singly or in combination.

The content of the surfactant is preferably, for example, 0.01 to 50 parts by weight per 100 parts by weight of the particulate substance, based on the solid content.

The temperature and time for drying can be selected as appropriate, depending on the volatility of the dispersion medium.

The average thickness of the lubricant layer 14 is, for example, 0.05 to 3 μm, preferably 0.05 to 2.5 μm, more preferably 0.05 to 2 μm, or 0.3 to 2 μm.

The average thickness can be obtained by a known method such as a non-contact surface measurement using a laser beam or an electron beam.

According to the invention, since the lubricant layer with a specific three-dimensional surface roughness is formed on a surface of the porous film, the winding cores can be smoothly pulled out of the wound electrode assembly. Thus, the separator of the invention is particularly advantageous in producing an electrode assembly for a prismatic battery. It suppresses the electrode assembly from becoming deformed when the winding cores are pulled out (for example, it suppresses the innermost portion of the electrode assembly from being dragged out together with the winding cores and protruding from the end thereof). When the electrode assembly becomes significantly deformed due to the removal of the winding cores, large friction occurs between the winding cores and the separators, and thus the separator is highly likely to be damaged. Therefore, by suppressing the deformation of the electrode assembly, it is possible to produce a highly reliable electrode assembly.

Also, since the process of pulling out the winding cores is smoothly performed constantly, there is no need to constantly monitor the process, thereby resulting in reduced production costs.

### (Porous Film)

The porous film 12 does not necessarily have the heat-resistant porous layer 18 as long as it has the porous polyolefin layer 16. When the porous film 12 is composed only of the polyolefin layer 16, the lubricant layer 14 is formed on at least one surface of the polyolefin layer 16.

### (1) Polyolefin Layer

The polyolefin layer 16 is a porous layer containing a polyolefin or a copolymer thereof, such as the above-mentioned PE, polypropylene (PP), or an ethylene-propylene copolymer.

In the event of an abnormal increase in battery temperature, when a polyolefin is used, the pores of the polyolefin layer are closed (shut down) at temperatures of approximately 120° C. to 150° C., thereby cutting off the current and stopping the battery reactions. Thus, a further temperature increase can be suppressed.

The polyolefin layer may contain other polymers than the polyolefin. The kind and/or amount of other polymers used can be selected to prevent softening, melting, or shrinking of the polyolefin layer 16.

Examples of other polymers are thermoplastic polymers including: styrene polymers such as polystyrene, rubber-containing polystyrene, and an acrylonitrile-styrene copolymer; polyesters such as polyethylene terephthalate; polyamides such as polyamide 6 and polyamide 12; acryl polymers such as polymethyl methacrylate; cellulose derivatives; and thermoplastic elastomers.

The content of the polyolefin in the porous film is, for example, 50 to 100% by weight.

The thickness of the polyolefin layer is preferably in the range of 5 to 200 μm.

The average pore size of the polyolefin layer is preferably 0.05 to 2 μm.

The porosity of the polyolefin layer is preferably, for example, 25 to 75% by volume.

The polyolefin layer may be a commercially available porous film, or may be a film obtained by forming a polymer material (a polymer material containing a polyolefin) into a film by a known porous-film formation method (e.g., extrusion, blow molding, inflation molding, or coating) and stretching the film. The stretching may be a uniaxial or biaxial stretching. In forming the film, for example, a known pore-forming agent may be used.

### (2) Heat-Resistant Porous Layer

In terms of preventing the polyolefin layer 16 from shrinking, the porous film 12 may have the heat-resistant porous layer 18. When the content of the polyolefin in the polyolefin layer 16 is large, it is advantageous to form the heat-resistant porous layer 18 on the surface thereof. The heat-resistant porous layer 18 (the material of the heat-resistant porous layer) has a higher melting point or heat deformation temperature than the polyolefin layer. Such a heat-resistant porous layer usually contains a highly heat-resistant polymer.

Examples of heat-resistant polymers include: polyolefins with a melting point of 150° C. or more, such as PP; amide-bond containing polymers such as polyamides, polyamide copolymers, and aramid; fluorine-containing polymers such as polyvinylidene fluoride (PVDF), a vinylidene fluoride-hexafluoropropylene (HFP) copolymer (PVDF-HFP), and PTFE; imide-bond containing polymers such as polyimides (PI), polyamide-imides (PAI), and polyetherimides (PEI); polyalkylene arylates such as polyethylene terephthalate (PET), polypropylene terephthalate (PPT), polytrimethylene terephthalate (PTT), polybutylene terephthalate (PBT), polyethylene naphthalate (PEN), and polybutylene naphthalate (PBN); polyarylates (PAR); sulfone-group containing polymers such as polysulfones (PSF) and polyethersulfones (PES); polyphenylene ethers (PPE); polycarbonates (PC); polyphenylene sulfides (PPS); aromatic polyether ketone polymers such as polyether ketones (PEK) and polyether ether ketones (PEEK); polyacetals (POM); and polyether nitriles (PEN).

The above-mentioned polymers can be used singly or in combination to form the heat-resistant porous layer 18. It is also possible to use other polymers in combination with the above-mentioned polymers.

Among the above-mentioned polymers, at least one selected from the group consisting of amide-bond containing polymers, fluorine-containing polymers, imide-bond containing polymers, and polyolefins is preferable. In particular, for example, PP, PVDF, PVDF-HFP, PI, PAI, and aramids are preferable.

The melting point or heat deformation temperature of the polymer material for the heat-resistant porous layer is, for example, higher than 150° C. and not higher than 800° C.

The heat-resistant porous layer 18 may contain an inorganic filler, if necessary. For example, the above-mentioned inorganic compounds can be used as the inorganic filler. Among the inorganic fillers, ceramic particles such as silica, alumina, titania, magnesia, and zirconia in particular are preferable.

The mean particle size of the inorganic filler is preferably 0.001 to 2 μm.

The content of the inorganic filler is 1 to 1000 parts by weight, preferably 10 to 700 parts by weight, and more preferably 50 to 500 parts by weight per 100 parts by weight of the raw material polymer(s) constituting the heat-resistant porous layer 18.

The thickness of the heat-resistant porous layer 18 can be selected from the range of 0.01 to 50 μm, preferably 0.1 to 20 μm, and more preferably 0.5 to 10 μm.

The average pore size and porosity of the heat-resistant porous layer 18 can be selected from the same range as that for the porous film.

The heat-resistant porous layer 18 can be formed by applying a coating liquid containing a raw material polymer onto a porous polyolefin layer by a known coating method and drying it. The coating liquid can be a solution or dispersion containing a raw material polymer. Examples of the solvent of the coating liquid include: alcohols (e.g., C₂₋₄ alkanols or C₂₋₄ alkane diols) such as methanol, ethanol, and ethylene glycol; ketones such as acetone; ethers such as diethyl ether and tetrahydrofuran; amides such as dimethylformamide; nitriles such as acetonitrile; sulfoxides such as dimethyl sulfoxide; and n-methyl-2-pyrrolidone (NMP). These solvents can be used singly or in combination.

Also, a laminate film of the polyolefin layer 16 and the heat-resistant porous layer 18 may be formed by coextruding a raw material polymer for the polyolefin layer 16 and a raw material polymer for the heat-resistant porous layer 18 and stretching the obtained film.

The thickness of the whole separator is, for example, 5.05 to 250 μm, or 5.05 to 50 μm.

### [Lithium Secondary Battery]

### (Positive Electrode and Negative Electrode)

The positive electrode 2 comprises a positive electrode current collector and a positive electrode active material layer supported thereon. The positive electrode current collector can be a known positive electrode current collector for non-aqueous secondary batteries, for example, a foil of a metal such as aluminum, an aluminum alloy, stainless steel, titanium, or a titanium alloy. The thickness of the positive electrode current collector is, for example, 1 to 100 μm, preferably 5 to 70 μm, and more preferably 10 to 50 μm.

The positive electrode active material is not particularly limited if it is a material capable of absorbing and releasing lithium ions. For example, transition metal oxides such as LiCoO₂, LiNiO₂, LiMn₂O₄, LiNi_{0.4}Mn_{1.6}O₄, LiCO_{0.3}Ni_{0.7}O₂, V₂O₅, MnO₂, LiCoPO₄, LiFePO₄, LiCoPO₄F, LiFePO₄F, Li₄Ti₅O₁₂, Li₄Fe_{0.5}Ti₅O₁₂, and Li₄Zn_{0.5}Ti₅O₁₂, sulfides such as TiS₂ and LiFeS₂, mixtures thereof, and such materials with various metal elements added thereto can be used as the positive electrode active materials.

The positive electrode active material layer contains a conductive agent, a binder, etc., in addition to the positive electrode active material. Examples of conductive agents include: carbon blacks such as acetylene black, ketjen black, channel black, furnace black, lamp black, and thermal black; various graphites such as natural graphites and artificial graphites; and conductive fibers such as carbon fiber and metal fiber. Examples of positive electrode binders include: fluorocarbon resins such as polyvinylidene fluoride (PVdF), modified polyvinylidene fluoride, and polytetrafluoroethylene (PTFE); styrene-butadiene copolymer rubber particles (SBR) or modified SBR, and rubber particle binders with an acrylate unit; and cellulose derivatives such as carboxymethyl cellulose (CMC).

The thickness of the positive electrode active material layer is, but not particularly limited to, for example, 0.1 to 150 μm, preferably 1 to 100 μm, and more preferably 10 to 90 μm.

The negative electrode 3 comprises a negative electrode current collector and a negative electrode active material layer supported thereon. The negative electrode current collector can be a known negative electrode current collector for non-aqueous secondary batteries, for example, a foil of a metal such as copper, a copper alloy, nickel, a nickel alloy, or stainless steel. The thickness of the negative electrode current collector is, for example, 1 to 100 μm, preferably 2 to 50 μm, and more preferably 5 to 30 μm.

Examples of negative electrode active materials include metals including at least one selected from the group consisting of Li, Al, Zn, Sn, In, Si, Ta, and Nb, alloys thereof, oxides thereof (e.g., SiO_{0.3}, Ta₂O₅, and Nb₂O₅), carbon materials such as graphite and carbon nanotubes, lithium titanium oxides with a spinel structure such as Li₄Ti₅O₁₂, Li₄Fe_{0.5}Ti₅O₁₂, and Li₄Zn_{0.5}Ti₅O₁₂, sulfides such as TiS₂, nitrogen compounds such as LiCO_{2.6}O_{0.4}N and Ta₃N₅, mixtures thereof, and such materials with various metal elements added thereto. However, any material capable of absorbing and releasing lithium ions can be used in the negative electrode without particular limitation.

In addition to the negative electrode active material, the negative electrode active material layer may contain a negative electrode conductive agent (e.g., a conductive agent mentioned above as a positive electrode conductive agent) and/or a negative electrode binder (a binder mentioned above as a positive electrode), if necessary.

The thickness of the negative electrode active material layer is, but not particularly limited to, for example, 0.1 to 150 μm, preferably 1 to 120 μm, and more preferably 10 to 100 μm.

The positive electrode 2 and the negative electrode 3 can be produced by disposing a positive electrode active material or negative electrode active material on a current collector by methods including, but not limited to, application, sputtering, vapor deposition, aerosol deposition, CVD, and screen printing.

The positive or negative electrode active material layer can be formed on one face of a current collector, or may be formed on both faces.

### (Non-Aqueous Electrolyte)

For the non-aqueous electrolyte, it is desirable to use a non-aqueous solvent in order to use lithium ions for charge/discharge. More preferably, the solvent has a high ion conductivity when a lithium salt is mixed therein. Preferable examples include ethylene carbonate (EC), propylene carbonate (PC), γ-butyrolactone (GBL), ethyl methyl carbonate (EMC), diethyl carbonate (DEC), and dimethyl carbonate (DMC). These solvents may be used singly or in combination. It is also more preferable to use a solvent mixture containing EC, which is a high dielectric-constant solvent.

The lithium salt used in the non-aqueous electrolyte is not particularly limited if it is capable of dissolving in such a non-aqueous solvent and being used as the electrolyte for a lithium secondary battery. For example, LiPF₆, LiBF₄, LiClO₄, LiN(C₂F₅SO₂)₂, and LiN(CF₃SO₂)₂ are preferable as lithium salts. These lithium salts can be used singly or in combination. It is preferable to use LiBF₄ in combination with other lithium salt(s), since LiBF₄ has a low conductivity when dissolved in a non-aqueous solvent, compared with LiPF₆ and LiClO₄.

The concentration of lithium salt in the non-aqueous electrolyte is, for example, 0.1 to 3 mol/L, preferably 0.2 to 2.5 mol/L, and more preferably 0.5 to 2 mol/L. Generally, when a non-aqueous electrolyte has a low concentration, it has a low ion conductivity. When the concentration is high, ion dissociation becomes difficult. Therefore, the ion conductivity tends to become low when the lithium salt concentration is too high and too low.

The invention is hereinafter described with reference to Examples. However, the invention is not to be construed as being limited to the following Examples.

### EXAMPLES

Examples of the invention are hereinafter described, but the invention is not to be construed as being limited to these Examples.

### Example 1

The separator 4 illustrated in FIG. 3 was produced in the following procedure.

(1) A 20-μm thick porous polyethylene film was used as the polyolefin layer 16. This film was produced by molding polyethylene by melt-extrusion and biaxially stretching the obtained product. The size of the pores thereof was set to 0.1 to 1 μm in order to prevent the materials having fallen off the positive electrode 2 and the negative electrode 3 such as the active material, the binder, and the conductive agent from passing therethrough.

(2) As the heat-resistant porous layer 18, a 3.5-μm thick, polyamide-containing porous film was formed on a surface of the polyolefin layer 16. The polyamide-containing porous film was formed by applying a solution of a polyamide in N-methyl-2-pyrrolidone (NMP) onto a surface of the polyolefin layer 16 and drying it. In the solution was dispersed 200 parts by weight of an inorganic oxide (alumina with a mean particle size of 0.013 μm) per 100 parts by weight of the polyamide.

(3) A dispersion was prepared by dispersing spherical PTFE particles (particulate substance 22) with a mean particle size of 0.2 μm in a mixture of a surfactant and water, and the dispersion was applied onto a surface of the heat-resistant porous layer 18. Thereafter, the water was evaporated to form the lubricant layer 14.

The weight of the dried particulate substance 22 contained in the lubricant layer 14 was 0.5 g per 1 m² of the surface of the heat-resistant porous layer 18 (i.e., the surface of the porous film 12). Also, the surface roughness Sa of the lubricant layer 14 measured by an electron beam 3D roughness analyzer (ERA-8800 available from Elionix Inc.) was 1.0 μm. Therein, the acceleration voltage was set to 5 kV, and the observation magnification was set to 200×.

(4) The positive electrode 2 was produced as follows. A slurry was prepared by mixing lithium cobaltate (LiCoO₂) serving as a positive electrode active material, acetylene black (AB) as a conductive agent, and PVDF as a binder in a weight ratio of 100:4:3 and mixing them with NMP serving as a solvent.

This slurry was applied onto both faces of an aluminum foil (thickness 15 μm) serving as a positive electrode current collector, dried in an atmosphere of 110° C. for 30 minutes, and rolled to obtain the positive electrode 2. The thickness of the positive electrode 2 was 160 μm.

(5) The negative electrode 3 was produced as follows. A slurry was prepared by mixing artificial graphite serving as a negative electrode active material, a styrene-butadiene copolymer rubber particle binder as a binder, and carboxymethyl cellulose (CMC) as a thickener in a weight ratio of 100:1:1, and mixing them with water serving as a dispersion medium.

This slurry was applied onto both faces of a copper foil (thickness 10 μm) serving as a negative electrode current collector, dried in an atmosphere of 110° C. for 30 minutes, and rolled to obtain the negative electrode 3. The thickness of the negative electrode 3 was 180 μm.

(6) The electrode assembly 20 as illustrated in FIG. 1 was produced as follows. The ends of two long-strip-shaped separators 4 produced by the above-described steps (1) to (3) were clamped between two plate-shaped, rectangular winding cores 21. With the separators 4 being pulled by a load of 500 gf (=500×980.665 dyn), the separators 4 were spirally wound together with the positive electrode 2 and the negative electrode 3. The winding was done, with the negative electrode 3 being in contact with the separator 4 forming the innermost layer.

After the positive electrode 2, the negative electrode 3, and the two separators 4 were wound for a predetermined length to form the electrode assembly 20, the clamping two winding cores 21 were released, and the winding cores 21 were pulled out of the electrode assembly 20 in the direction A, as illustrated in FIG. 2. At this time, whether the winding cores 21 were smoothly pulled out was observed, and the appearance of the produced electrode assembly 20 was visually inspected.

(7) Production of lithium secondary battery

The electrode assembly 20 was inserted in a prismatic aluminum battery case with an opening and a bottom. A non-aqueous electrolyte was injected into the case 1, and the opening was sealed. In this manner, 1000 lithium secondary batteries were produced. Therein, only the electrode assemblies 20 having passed the visual inspection were used. The non-aqueous electrolyte was prepared by dissolving LiPF₆ (lithium salt) at a concentration of 1 mol/L in a solvent mixture of ethylene carbonate (EC) and propylene carbonate (PC) in a volume ratio of 1:3.

The 1000 lithium secondary batteries thus produced were subjected to a charge/discharge test to evaluate their battery performance. In the charge/discharge test, the respective batteries were charged at a current of 2 hour rate until the voltage between the terminals became 4.2 V, and then discharged until the voltage between the terminals lowered to 3.0 V. A 30-minute interval was provided between the charge and the discharge. After this charge/discharge cycle was repeated 200 times, the discharge capacity was measured, and the measured value was compared with the measured value of the initial discharge capacity to calculate the ratio to the initial discharge capacity being defined as 100. If the Ratio was 70 or more, the battery performance was determined as being good.

### Example 2

A thousand lithium secondary batteries were produced in the same manner as in Example 1, except that spherical particles of perfluoroethylene propylene copolymer (FEP) with a mean particle size of 0.2 μm were used as the particulate substance 22, and that the weight of the dried particulate substance 22 in the lubricant layer 14 was changed to 0.8 g/m². The surface roughness Sa of the lubricant layer 14 formed was 1.4 μm.

In the formation of the electrode assembly 20, how the winding cores 21 could be pulled out was observed, and the appearance of the electrode assembly 20 produced was visually inspected, in the same manner as in Example 1. Also, the battery performance was evaluated in the same manner as in Example 1.

### Example 3

Lithium secondary batteries were produced in the same manner as in Example 1, except that spherical particles of SiO₂ with a mean particle size of 0.1 μm were used as the particulate substance 22, and that the weight of the dried particulate substance 22 in the lubricant layer 14 was changed to 0.3 g/m². The surface roughness Sa of the lubricant layer 14 formed was 0.2 μm.

In the formation of the electrode assembly 20, how the winding cores 21 could be pulled out was observed, and the appearance of the electrode assembly 20 produced was visually inspected, in the same manner as in Example 1. Also, the battery performance was evaluated in the same manner as in Example 1.

### Comparative Example 1

Lithium secondary batteries were produced in the same manner as in Example 1, except that spherical particles of PTFE with a mean particle size of 0.2 μm were used as the particulate substance 22, and that the weight of the dried particulate substance 22 in the lubricant layer 14 was changed to 2.0 g/m². The surface roughness Sa of the lubricant layer 14 formed was 1.5 μm.

In the formation of the electrode assembly 20, how the winding cores 21 could be pulled out was observed, and the appearance of the electrode assembly 20 produced was visually inspected, in the same manner as in Example 1. Also, the battery performance was evaluated in the same manner as in Example 1.

### Comparative Example 2

Lithium secondary batteries were produced in the same manner as in Example 1, except that spherical particles of PTFE with a mean particle size of 0.2 μm were used as the particulate substance 22, and that the weight of the dried particulate substance 22 in the lubricant layer 14 was changed to 0.1 g/m². The surface roughness Sa of the lubricant layer 14 formed was 0.1 μm.

In the formation of the electrode assembly 20, how the winding cores 21 could be pulled out was observed, and the appearance of the electrode assembly 20 produced was visually inspected, in the same manner as in Example 1. Also, the battery performance was evaluated in the same manner as in Example 1.

### Comparative Example 3

Lithium secondary batteries were produced in the same manner as in Example 1, except that a separator consisting only of the porous film 12 was produced without forming the lubricant layer 14.

In the formation of the electrode assembly 20, how the winding cores 21 could be pulled out was observed, and the appearance of the electrode assembly 20 produced was visually inspected, in the same manner as in Example 1. Also, the battery performance was evaluated in the same manner as in Example 1.

### Example 4

Lithium secondary batteries were produced in the same manner as in Example 1, except that in the formation of the electrode assembly 20, the lubricant layer 14 was formed only on the portion of the porous film 12 to come into contact with the winding core 21.

In the formation of the electrode assembly 20, how the winding cores 21 could be pulled out was observed, and the appearance of the electrode assembly 20 produced was visually inspected, in the same manner as in Example 1. Also, the battery performance was evaluated in the same manner as in Example 1.

Table 1 shows the evaluation results of the lithium secondary batteries produced in Examples and Comparative Examples together with the surface roughness of the lubricant layer.

Removal observation, visual inspection, and battery performance were evaluated as follows.

### (Removal Observation and Visual Inspection)

A: the winding cores were smoothly pulled out and the innermost portion of the separator was not dragged out together with the winding cores being pulled out.

B: the innermost portion of the separator was dragged out together with the winding cores being pulled out.

### (Battery Performance)

A: The discharge capacity measured after the repeated charge/discharge was 70 or more, relative to the initial discharge capacity being defined as 100.

B: The discharge capacity measured after the repeated charge/discharge was less than 70, relative to the initial discharge capacity being defined as 100.

TABLE 1

| | | Removal | |
|---|---|---|---|
| | Surface | observation and | |
| | roughness Sa | visual | Battery |
| | (μm) | inspection | performance |
| Example 1 | 1.0 | A | A |
| Example 2 | 1.4 | A | A |
| Example 3 | 0.2 | A | A |
| Comparative | 1.5 | A | B |
| Example 1 | | | |
| Comparative | 0.1 | B | A |
| Example 2 | | | |
| Comparative | — | B | A |
| Example 3 | | | |
| Example 4 | 1.0 | A | A |

### [Evaluation]

As shown in Table 1, in each of Examples 1 to 4 in which the surface roughness Sa of the lubricant layer 14 is in a specific range, as a result of observation of how the winding cores 21 could be pulled out of approximately 1000 electrode assemblies 20, the winding cores 21 were smoothly pulled out in all the Examples. Also, as a result of visual inspection of the produced electrode assemblies 20, none of the electrode assemblies 20 exhibited such a defect of the innermost portion being dragged out 1 mm or more together with the winding cores 21 being pulled out. This result is probably because the suitable surface roughness Sa of the lubricant layer 14 provided the lubricant layer 14 with sufficient slidability.

Also, in Example 4 in which the lubricant layer 14 was formed only on the portion of the porous film 12 to come into contact with the winding core 21 when the electrode assembly 20 was formed, a similar result to those of the other Examples was obtained. From this, it can be understood that the effects of the invention can be achieved if only the lubricant layer 14 is formed on the portion of the separator 14 to come into contact with the winding core 21.

On the other hand, in Comparative Example 2 in which the surface roughness Sa of the lubricant layer 14 is 0.1 μm, when the winding cores 21 were pulled out of the electrode assembly 20, the innermost portion of the separator 4 was found to be dragged out. In the visual inspection of some of the electrode assemblies 20, the innermost portion of the separator 4 was dragged out a maximum of approximately 1 mm. This is probably because the surface roughness Sa of the lubricant layer 14 was too small, thus being unable to provide the lubricant layer 14 with sufficient slidability.

Also, in Comparative Example 1 in which the surface roughness Sa of the lubricant layer 14 is 1.5 μm, the winding cores 21 were smoothly pulled out of the electrode assembly 20, and none of the electrode assemblies 20 was defective in the visual inspection. However, in the result of the charge/discharge test, only Comparative Example 1 had lithium secondary batteries with poor charge/discharge cycle characteristics.

Using the batteries with poor cycle characteristics, their electrode assemblies were disassembled and observed. As a result, it was confirmed that a large amount of the particulate substance 22 having fallen off the separator 4 was embedded in the positive electrode 2, the negative electrode 3, and the separator 4.

The above results indicate that it is preferable to form the lubricant layer 14 so that the surface roughness Sa is in the range from more than 0.1 μm to less than 1.5 μm in order to provide the separator 4 with sufficient slidability with respect to the winding core 21 and prevent the lubricant layer 14 from having an adverse effect on the battery performance.

### INDUSTRIAL APPLICABILITY

The separator for a lithium secondary battery according to the invention has good core removal properties even when electrodes and the separator are tightly wound to form an electrode assembly. Therefore, it is useful as the separator for lithium secondary batteries which are required to provide high capacity and high output as the power source for mobile and other devices.

### REFERENCE SIGNS LIST

1 Battery Case
2 Positive Electrode
3 Negative Electrode
4 Separator
10 Lithium Secondary Battery
12 Porous Film
14 Lubricant Layer
18 Heat-Resistant Porous Layer
20 Electrode Assembly

1. A separator for a lithium secondary battery, comprising:
a porous film including a polyolefin layer; and
a lubricant layer disposed on a surface of the porous film, the lubricant layer including a particulate substance and having a three-dimensional surface roughness of 0.15 to 1.45 μm.

2. The separator in accordance with claim 1, wherein the three-dimensional surface roughness of the lubricant layer is 0.2 to 1.4 μm.

3. The separator in accordance with claim 1, wherein the particulate substance adheres to the surface of the porous film by electrostatic attraction.

4. The separator in accordance with claim 1, wherein the lubricant layer contains 0.1 to 2 g of the particulate substance per 1 m² of the surface of the porous film.

5. The separator in accordance with claim 1, wherein the particulate substance has a mean particle size of 0.01 to 1 μm.

6. The separator in accordance with claim 1, wherein the particulate substance comprises at least one selected from an organic polymer compound and an inorganic compound.

7. The separator in accordance with claim 6, wherein the organic polymer compound comprises at least one selected from a fluorine-containing polymer and a polyolefin.

8. The separator in accordance with claim 6, wherein the inorganic compound comprises at least one selected from the group consisting of SiO₂, Al₂O₃, TiO₂, MgO, ZrO₂, CaO, CaCO₃, talc, and mica.

9. The separator in accordance with claim 1, wherein the porous film further includes a heat-resistant porous layer between the polyolefin layer and the lubricant layer, and the heat-resistant porous layer has a higher melting point or heat deformation temperature than the polyolefin layer.

10. The separator in accordance with claim 1, wherein the heat-resistant porous layer includes at least one selected from the group consisting of amide-bond containing polymers, fluorine-containing polymers, imide-bond containing polymers, and polyolefins.

11. The separator in accordance with claim 1, wherein the lubricant layer has an average thickness of 0.05 to 3 μm, the polyolefin layer has a thickness of 5 to 200 μm, and the whole thickness of the separator is 5.05 to 250 μm.

12. A lithium secondary battery comprising:
an electrode assembly comprising a positive electrode, a negative electrode, and the separator of claim 1 interposed between the positive electrode and the negative electrode;
a non-aqueous electrolyte; and
a battery case for housing the electrode assembly and the non-aqueous electrolyte.

13. The lithium secondary battery in accordance with claim 12, wherein the lubricant layer is disposed at a portion of the separator to be disposed at an innermost portion of the electrode assembly.

14. The lithium secondary battery in accordance with claim 12 having a prismatic shape, wherein the electrode assembly has a rectangular flat face and curved side faces on both sides of the flat face.

15. A prismatic lithium secondary battery comprising:
an electrode assembly comprising a positive electrode, a negative electrode, and a separator interposed between the positive electrode and the negative electrode;
a non-aqueous electrolyte; and
a battery case for housing the electrode assembly and the non-aqueous electrolyte,
wherein the separator comprises a porous film including a polyolefin layer and a lubricant layer disposed on a surface of the porous film, the lubricant layer including a particulate substance,
the lubricant layer is disposed at a portion of the separator to be disposed at an innermost portion of the electrode assembly, and
the electrode assembly has a rectangular flat face and curved side faces on both sides of the flat face.
